(19) United States
(12) Patent Application Publication
(10) Pub. No.: US 2025/0039927 A1
(43) Pub. Date: Jan. 30, 2025

(54) DEVICE COLLABORATION OVER UNLICENSED BAND

(71) Applicant: MEDIATEK INC., Hsinchu (TW)

(72) Inventors: Chun-Hao Fang, Hsinchu (TW); Lung-Sheng Tsai, Hsinchu (TW)

(21) Appl. No.: 18/776,699

(22) Filed: Jul. 18, 2024

Related U.S. Application Data
(60) Provisional application No. 63/516,187, filed on Jul. 28, 2023.

(51) Int. Cl. H04W 74/0808; H04W 16/14; H04W 88/04

(52) U.S. Cl. CPC H04W 74/0808; H04W 16/14; H04W 88/04

(57) ABSTRACT

In an aspect of the disclosure, a method, a computer-readable medium, and an apparatus are provided. The apparatus may be a UE. The UE discovers a relay wireless device for local communications on an unlicensed carrier. The UE communicates, after a listen-before-talk (LBT) procedure is successful on the unlicensed carrier, data with the relay wireless device on the unlicensed carrier through the local communications for further communicating the data with a base station.

### CROSS-REFERENCE TO RELATED APPLICATION(S)

This application claims the benefits of U.S. Provisional Application Ser. No. 63/516,187, entitled “DEVICE COLLABORATION WITH UNLICENSED LOCAL LINK” and filed on Jul. 28, 2023, which is expressly incorporated by reference herein in their entirety.

### BACKGROUND

### Field

The present disclosure relates generally to communication systems, and more particularly, to techniques of device collaboration over an unlicensed band using listen-before-talk (LBT) and channel occupancy time (COT) sharing.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE discovers a relay wireless device for local communications on an unlicensed carrier. The UE communicates, after a listen-before-talk (LBT) procedure is successful on the unlicensed carrier, data with the relay wireless device on the unlicensed carrier through the local communications for further communicating the data with a base station.

In another aspect of the disclosure, a method, a computer-readable medium, and an apparatus are provided. The apparatus may be a wireless device. The wireless device discovers a user equipment (UE) for local communications on an unlicensed carrier. The wireless device communicates data with the UE on the unlicensed carrier through the local communications for communicating the data between the UE and a base station after a listen-before-talk (LBT) procedure is successful on the unlicensed carrier.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a device collaboration scenario where a primary user equipment (UE) receives data signals from a base station through both a direct link and an indirect link via a relay device.

FIG. 8(A) is a diagram illustrating a downlink device collaboration scenario where a primary UE is served by a base station through both a direct link and an indirect link via a relay device.

FIG. 8(B) is a diagram illustrating a downlink device collaboration scenario where a primary UE is served by a base station only through an indirect link via a relay device.

FIG. 8(C) is a diagram illustrating an uplink device collaboration scenario where a primary UE transmits data signals to a base station using both a direct link and an indirect link via a relay device.

FIG. 8(D) is a diagram illustrating an uplink device collaboration scenario where a primary UE transmits data signals to a base station only through an indirect link via a relay device.

FIG. 9 is a diagram illustrating a device collaboration scenario where a relay device utilizes an unlicensed band for data forwarding to a primary UE.

FIG. 10 is a diagram illustrating an uplink device collaboration scenario where a primary UE transmits data signals to a base station using both a direct link and an indirect link via a relay device over an unlicensed band.

FIG. 11(A) is a diagram illustrating the overall listen-before-talk (LBT) procedure.

FIG. 11(B) is a diagram providing a detailed view of the defer duration within the listen-before-talk (LBT) procedure.

FIG. 12(A) is a diagram depicting the information exchange process for the frequency domain location of the LBT bandwidth when the relay device lacks a SIM card, requiring control signaling to be relayed through the primary UE.

FIG. 12(B) is a diagram depicting the information exchange process for the frequency domain location of the LBT bandwidth when the relay device has a SIM card, allowing direct communication with both the base station and the primary UE.

FIG. 13 is a diagram illustrating an example of information regarding the frequency domain location of the LBT bandwidth.

FIG. 14 is a diagram illustrating a downlink transmission procedure where the relay device performs LBT to determine the channel occupancy time for data forwarding.

FIG. 15 is a diagram illustrating a downlink transmission procedure where the primary UE performs LBT, acquires the channel occupancy time, and shares it with the relay device for data forwarding.

FIG. 16 is a diagram illustrating an uplink transmission procedure where the primary UE performs LBT to acquire the channel occupancy time for data transmission to the relay device.

FIG. 17 is a diagram illustrating the concept of channel occupancy time (COT) sharing in an unlicensed spectrum.

FIG. 18 is a diagram illustrating a COT sharing procedure for device collaboration, where the relay device acquires the COT for downlink transmission and shares the remaining time with the primary UE for uplink transmission.

FIG. 19 is a diagram illustrating a COT sharing procedure for device collaboration, where the relay device acquires the COT for downlink transmission and shares the remaining time with another primary UE for uplink transmission.

FIG. 20 is a diagram illustrating a COT sharing procedure for device collaboration, where the primary UE acquires the COT for uplink transmission and shares the remaining time with the base station for downlink transmission.

FIG. 21 is a diagram illustrating a COT sharing procedure for device collaboration, where the primary UE acquires the COT for uplink transmission and shares the remaining time with the base station for downlink transmission to another primary UE through another relay device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

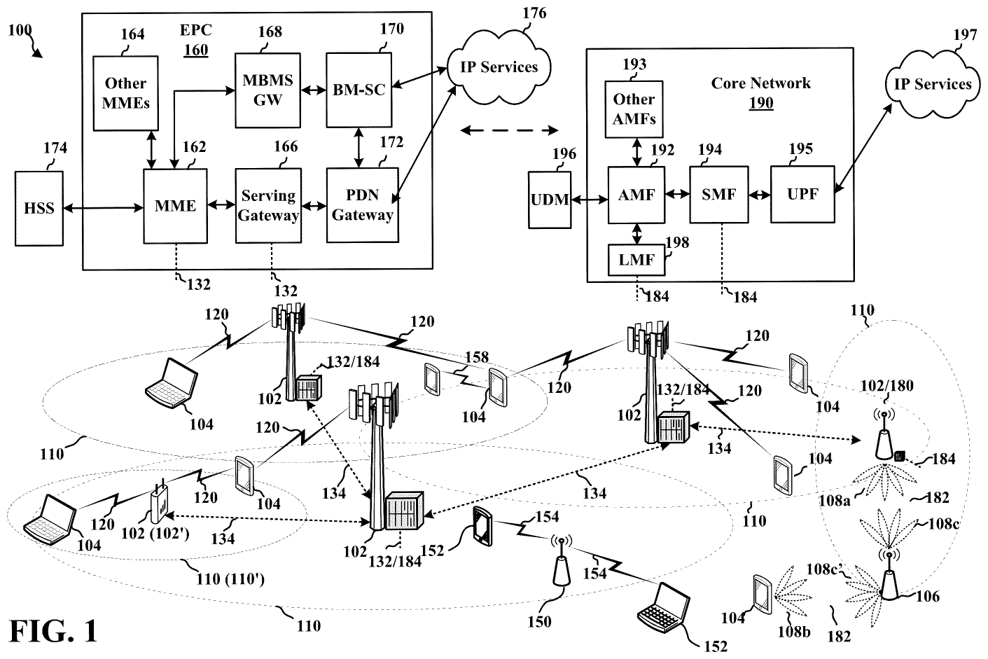

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHZ, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

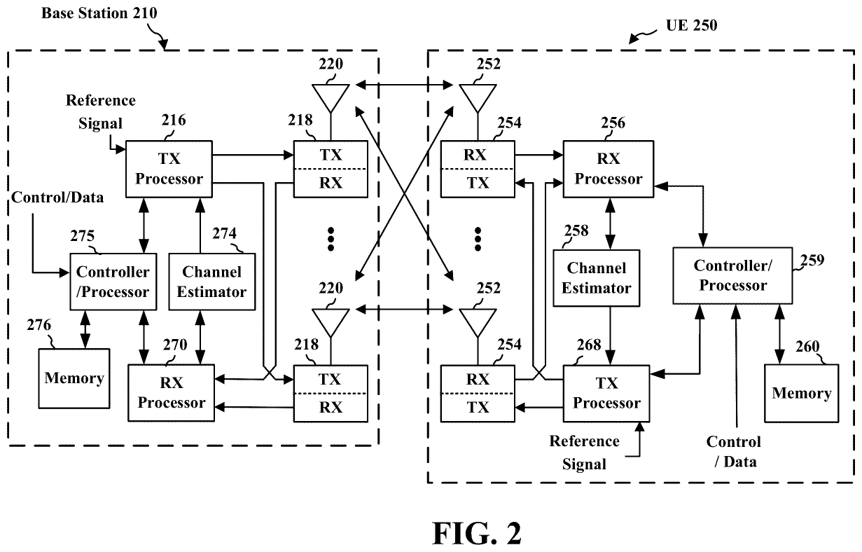

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

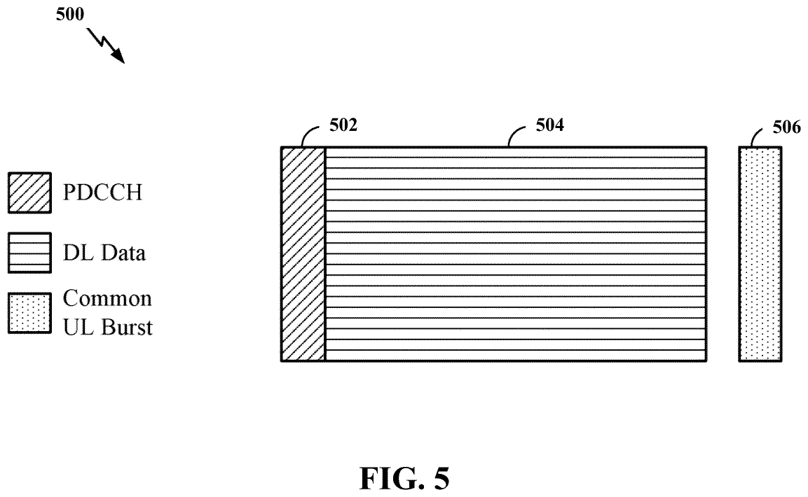

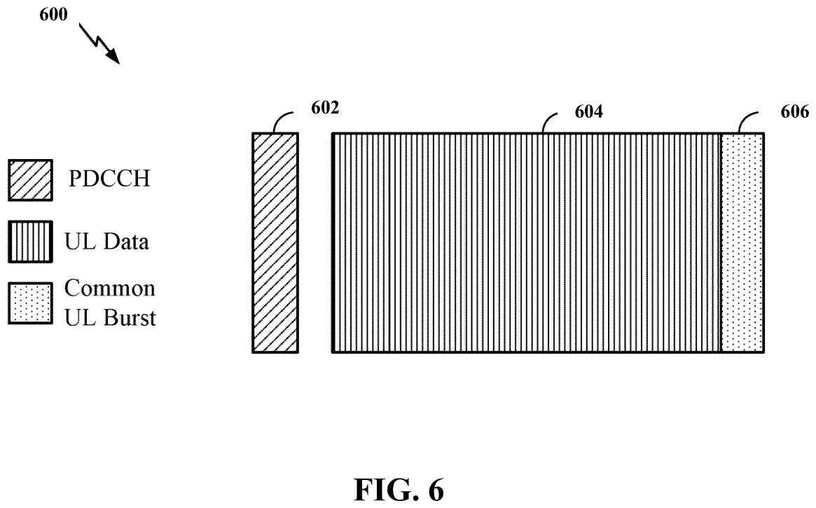

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

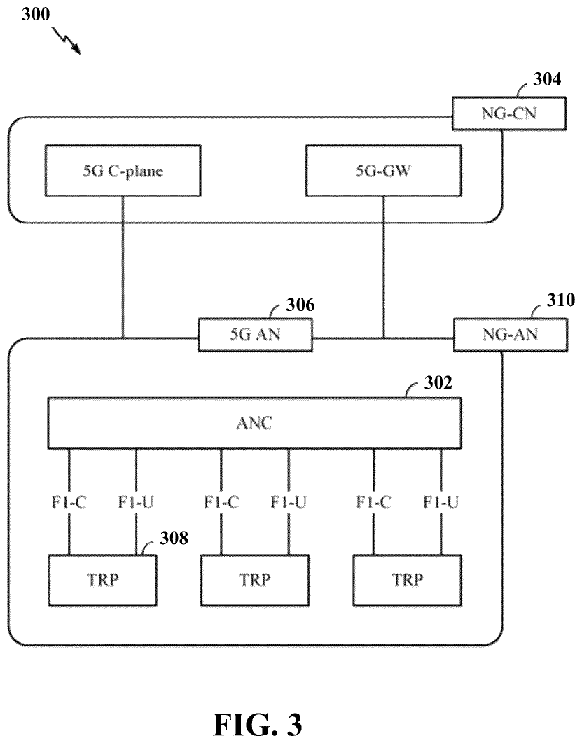

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

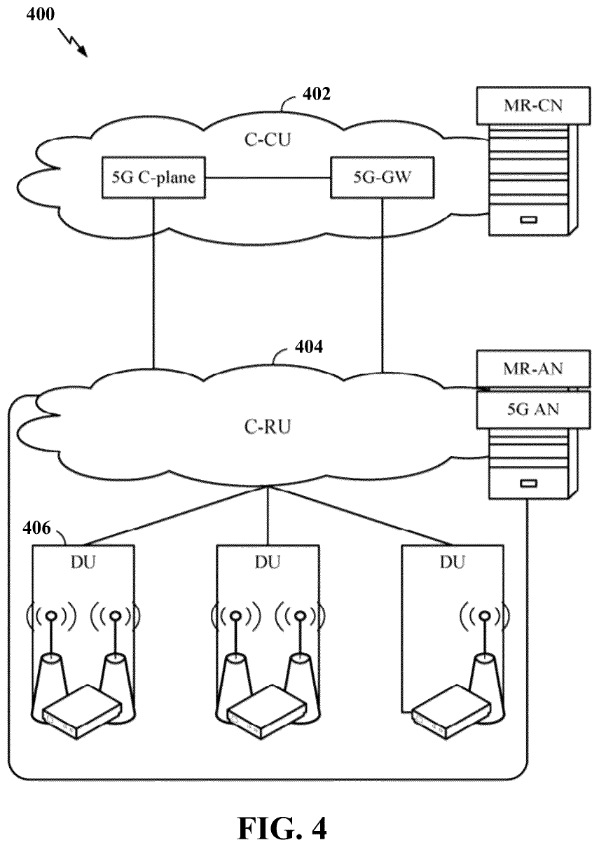

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

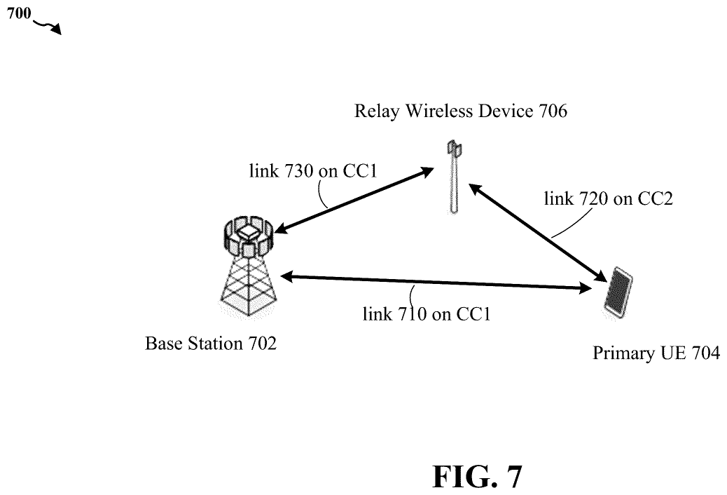

FIG. 7 is a diagram 700 illustrating the device collaboration scenario for enhancing downlink (DL) transmission. In this scenario, a primary UE 704 is served by a base station 702 in a first time-frequency resource, such as component carrier 1 (CC1). The primary UE 704 receives data signals transmitted by the base station 702 in CC1 via a direct link 710. A relay wireless device 706, for example an access point or another UE, is capable of receiving signals in the first time-frequency resource (CC1) via link 730 and forwarding the received signals to the primary UE 704 in a second time-frequency resource, such as component carrier 2 (CC2), via link 720.

The base station 702 is configured to transmit data signals to the primary UE 704 using the first time-frequency resource. This direct communication link between the base station 702 and the primary UE 704 is referred to as the direct link 710.

Additionally, the base station 702 transmits data signals to a relay wireless device 706 using the same first time-frequency resource, CC1, over the link 730. The relay wireless device 706 receives these signals and forwards them to the primary UE 704 using the second time-frequency resource, over the link 720. This indirect communication path from the base station 702 to the primary UE 704 via the relay wireless device 706 is referred to as the indirect link.

In this scenario, the primary UE 704 can receive data signals from both the direct link 710 and the indirect link (including the link 730 and the link 720). This setup allows the primary UE 704 to utilize multiple component carriers (CC1 and CC2), potentially increasing the rank and throughput of the communication system.

As shown, the primary UE 704, served by the base station 702 in the first time-frequency resource (e.g., CC1), receives data signals transmitted by the base station 702. The relay wireless device 706 is capable of receiving signals in the first time-frequency resource and forwarding the received signals in the second time-frequency resource (CC2). This frequency translation performed by the relay wireless device 706 allows the primary UE 704 to receive signals in both the first and second time-frequency resources, or only in the second time-frequency resource.

Device collaboration of the primary UE 704 and the relay wireless device 706 has the potential to increase the rank and enhance the throughput of the primary UE 704. The capacity of the primary UE 704 can be expressed as Nlog₂(1+SINR), where N is the number of receive antenna ports. By using the second component carrier (CC2), the capacity is not limited by the number of antenna ports in CC1 alone.

The relay wireless device 706 amplifies and forwards the received signal without decoding it. This functionality can be implemented in a general UE or a repeater or any wireless device has translation and forwarding capabilities. The first time-frequency resource and the second time-frequency resource can be in two different band (e.g., FR1 and FR2) or in the same band but not overlapping.

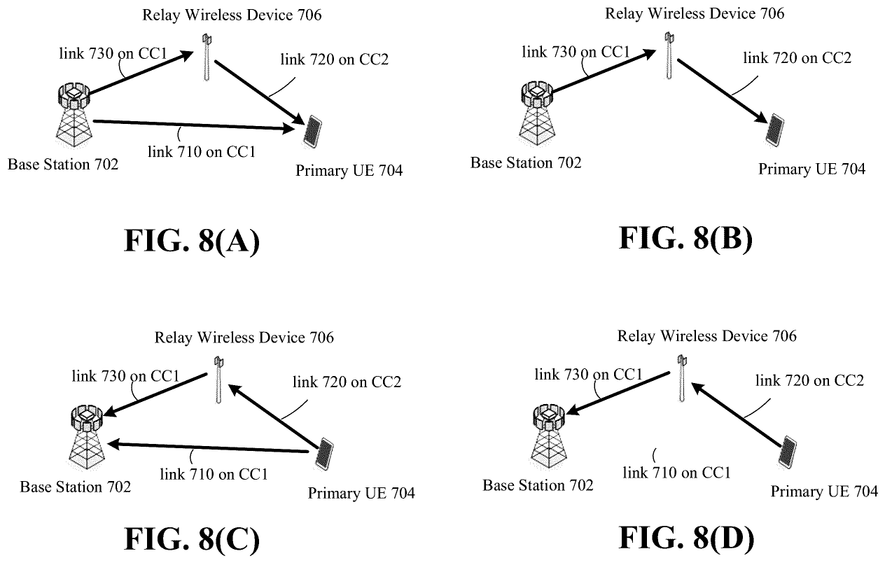

FIG. 8(A) illustrates a downlink (DL) device collaboration scenario where a primary UE 704 is served by a base station 702. The base station 702 transmits data signals to the primary UE 704 using the first time-frequency resource, such as component carrier 1 (CC1), over the direct link 710. Simultaneously, the base station 702 also transmits data signals to the relay wireless device 706 using the same first time-frequency resource (CC1) over a link 730. The relay wireless device 706 receives these signals and forwards them to the primary UE 704 using a second time-frequency resource, such as component carrier 2 (CC2), over the link 720. This setup allows the primary UE 704 to receive data signals from both the direct link 710 and the indirect link (link 730 and link 720), potentially increasing the rank and throughput of the communication system.

FIG. 8(B) illustrates a scenario where the primary UE 704 receives data only through the indirect link. In this case, the base station 702 transmits data signals to the relay wireless device 706 using the first time-frequency resource (CC1) over the link 730. The relay wireless device 706 then forwards these signals to the primary UE 704 using the second time-frequency resource (CC2) over the link 720. The primary UE 704 does not receive data directly from the base station 702 but relies on the relay wireless device 706 for data reception.

FIG. 8(C) illustrates an uplink (UL) device collaboration scenario where the primary UE 704 transmits data signals to the base station 702 using both the first time-frequency resource (CC1) and the second time-frequency resource (CC2). The primary UE 704 transmits data signals to the relay wireless device 706 using the second time-frequency resource (CC2) over a link 720. The relay wireless device 706 receives these signals and forwards them to the base station 702 using the first time-frequency resource (CC1) over a link 730. The primary UE 704 also transmits data signals directly to the base station 702 on CC1 over the direct link 710. Both the direct link and indirect link signals are received by the base station 702. This setup allows the primary UE 704 to utilize multiple component carriers for data transmission, potentially increasing the rank and throughput of the communication system.

FIG. 8(D) illustrates a scenario where the primary UE 704 transmits signals to the relay wireless device 706 using only the second time-frequency resource (CC2) over the link 720. The relay wireless device 706 translates these signals to the first time-frequency resource (CC1) and transmits the translated signals to the base station 702 over a link 730. In this scenario, the primary UE 704 does not transmit data directly to the base station 702 using the first time-frequency resource, but relies on the relay wireless device 706 for data transmission.

In the downlink (DL) case, the relay wireless device 706 must perform Listen-Before-Tdlk (LBT) before using the unlicensed spectrum (e.g., CC2) for data forwarding to the primary UE 704. This is necessary to avoid interference with other devices using the same unlicensed spectrum. If the LBT at the relay wireless device 706 passes, the primary UE 704 can receive data using both CC1 and CC2 (path combining mode). If the LBT fails, the primary UE 704 receives data only using CC1 (only direct link mode).

In the uplink (UL) case, the primary UE 704 must perform LBT before using the unlicensed spectrum (CC2) for data transmission to the relay wireless device 706. If the LBT at the primary UE 704 passes, the primary UE 704 can transmit data using both CC1 and CC2 (path combining mode). If the LBT fails, the primary UE 704 transmits data only using CC1 (only direct link mode).

Direct link refers to the communication link between the base station 702 and the primary UE 704 using CC1. Indirect link refers to the communication path from the base station 702 to the relay wireless device 706 using CC1, and from the relay wireless device 706 to the primary UE 704 using CC2. Local link refers to the link between the primary UE 704 and the relay wireless device 706 using CC2.

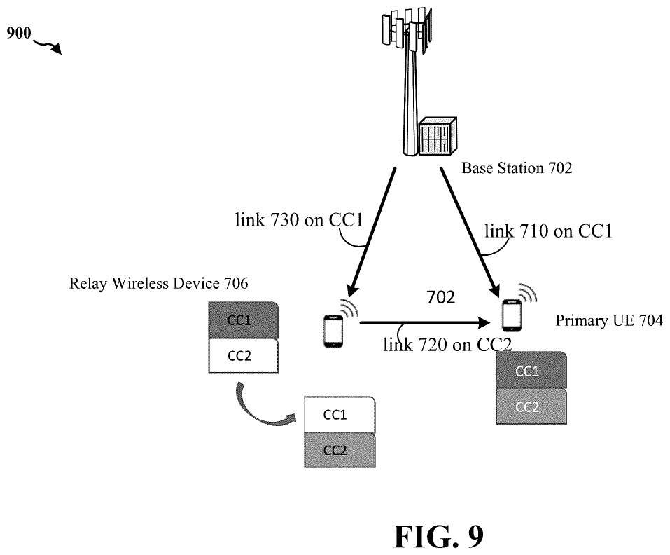

FIG. 9 is a diagram 900 illustrating the motivation for using an unlicensed band for the link 720 between the relay wireless device 706 and the primary UE 704. Similar to the scenario described in FIG. 8(A), the primary UE 704 is served by the base station 702 in the first time-frequency resource, such as component carrier 1 (CC1). The primary UE 704 receives data signals transmitted by the base station 702 in CC1 via the direct link 710. The base station 702 also transmits data signals to the relay wireless device 706 using the same first time-frequency resource (CC1) over the link 730. The relay wireless device 706 receives these signals and forwards them to the primary UE 704 using the second time-frequency resource, over the link 720.

When the second time-frequency resource (CC2) used for the link 720 is a licensed band, it occupies the base station's 702 resources. This may cause unwanted interference to other users served by the base station 702 on CC2. Allowing the relay wireless device 706 to use the base station's licensed resources without coordination could lead to such interference, which operators may want to avoid.

On the other hand, when CC2 is an unlicensed band, the device collaboration architecture becomes a network-transparent method to improve the user's throughput. Since the relay wireless device 706 uses unlicensed resources for the link 720, it does not interfere with the base station's 702 licensed resources. This approach may be more acceptable to operators, as it does not impact their network planning and resource allocation.

In this example, CC2 μsed by the relay wireless device 706 on the link 720 is an unlicensed band. Therefore, the relay wireless device 706 needs to perform Listen-Before-Tdlk (LBT) before transmitting to avoid interference with other devices that may be using the same unlicensed spectrum. LBT is a mechanism used in unlicensed bands to detect that the channel is free before transmission, thus avoiding collisions with other devices using the same resources. The relay wireless device 706 may perform LBT when it receives an indication, such as Downlink Control Information (DCI), that the base station 702 is about to transmit data to the primary UE 704.

If the LBT at the relay wireless device 706 is successful, indicating that the channel is free, the relay wireless device 706 can forward the data to the primary UE 704 on CC2. In this case, the primary UE 704 receives data using both CC1 and CC2, a mode referred to as the path combining mode. If the LBT at the relay wireless device 706 fails, suggesting that the channel is occupied, the primary UE 704 receives data only on CC1 through the direct link 710, a mode called the direct link mode.

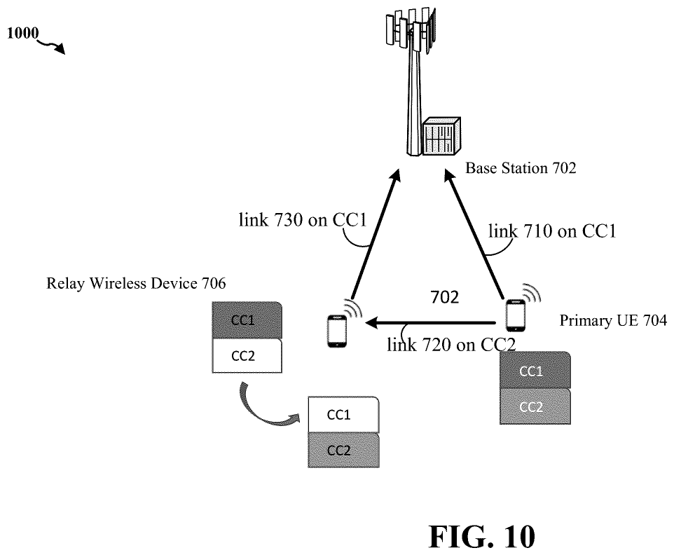

FIG. 10 is a diagram 1000 illustrating an uplink (UL) device collaboration scenario where the primary UE 704 transmits data signals to the base station 702 using both the first time-frequency resource (e.g., CC1) and the second time-frequency resource (e.g., CC2).

Similar to the scenario described in FIG. 8(C), the primary UE 704 transmits data signals to the relay wireless device 706 using the second time-frequency resource (CC2) over the link 720. The relay wireless device 706 receives these signals and forwards them to the base station 702 using the first time-frequency resource (CC1) over the link 730. The primary UE 704 also transmits data signals directly to the base station 702 on CC1 over the direct link 710. Both the direct link and indirect link signals are received by the base station 702. This setup allows the primary UE 704 to utilize multiple component carriers for data transmission, potentially increasing the rank and throughput of the communication system.

In the uplink procedure for device collaboration over the unlicensed band, the primary UE 704 performs LBT when it receives an indication to begin UL transmission. This indication is typically an uplink grant from the base station 702, informing the primary UE 704 that it can transmit uplink data. Upon receiving the uplink grant, the primary UE 704 initiates the LBT procedure.

The primary UE 704 transmits data using one of two modes, depending on the LBT result. When the LBT at the primary UE 704 passes, indicating that the channel is free, the primary UE 704 uses both CC1 and CC2 for data transmission in the path combining mode. It transmits data directly to the base station 702 using CC1 (direct link 710) and to the relay wireless device 706 using CC2 (link 720). The relay wireless device 706 then forwards the data to the base station 702 using CC1 (link 730). When the LBT at the primary UE 704 fails, suggesting that the channel is occupied, the primary UE 704 uses only CC1 for data transmission in the only direct link mode. It transmits data directly to the base station 702 using the direct link 710.

The relay wireless device 706 may use the same uplink resources on link 730 as the primary UE 704 uses on link 710. This allows the base station 702 to receive the combined signal from both the direct link 710 and the indirect link (link 720 and link 730), potentially improving the received signal quality and increasing the achievable throughput.

The base station 702 does not need to send a separate grant to the relay wireless device 706 for uplink transmission. The relay wireless device 706's forwarding of data may be controlled by the primary UE 704, which determines whether it needs the relay wireless device 706 to forward its data based on the LBT result and the desired transmission mode (path combining or direct link only).

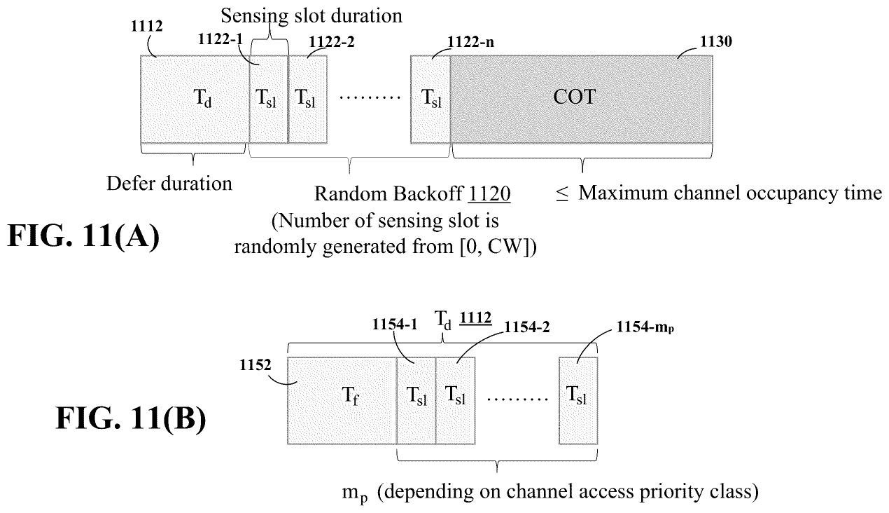

FIGS. 11(A) and 11(B) are diagrams 1100 and 1150, respectively, illustrating the channel sensing structure in unlicensed specifications for Listen-Before-Tdlk (LBT). This structure provides that a device can access the channel only when it is idle, avoiding collisions with other devices using the same unlicensed spectrum.

LBT is a mechanism used in unlicensed bands to detect that the channel is free before transmission, thus avoiding collisions with other devices using the same resources. LBT is be performed before transmission in an unlicensed band. If the sensed energy within an LBT bandwidth exceeds a certain threshold, the primary UE 704 and the relay wireless device 706 will regard the resource within the LBT bandwidth as busy. The LBT for transmitting or forwarding signals will be deferred. Transmission or forwarding of signals will not begin until the sensed energy does not exceed the certain threshold for a specified duration.

FIG. 11(A) depicts the overall LBT procedure, which includes a defer duration 1110, a random backoff 1120, and a channel occupancy time (COT) 1130.

The defer duration T_{d} 1112 represents a time period during which the device senses the channel for activity. The defer duration is calculated as T_{d}=16+mₚ×9 microseconds, where mₚ is the number of sensing slots within the defer duration. The value of mₚ depends on the channel access priority class (CAPC) of the data to be transmitted.

Following the defer duration, the device enters a random backoff period 1120. This period consists of a random number of sensing slots, each with a duration of Tₛₗ=9 microseconds. The number of sensing slots in the random backoff is randomly generated within a range defined by a contention window (CW). The purpose of the random backoff is to further reduce the probability of collisions by introducing a random delay before channel access.

If the channel is sensed as idle during both the defer duration 1110 and the random backoff 1120, the device can start transmitting data. The channel occupancy time 1130 (COT) represents the allowed transmission duration on the channel.

FIG. 11(B) provides a detailed breakdown of the defer duration T_{d} 1112. The defer duration is composed of a fixed time period T_{f} 1152 and mₚ sensing slots with duration Tₛₗ 1154, where mₚ depends on the channel access priority class (CAPC).

Table 1 shows the mapping between the CAPC, the number of sensing slots (mₚ), minimum and maximum contention window sizes (CW_{min,p} and CW_{max,p}), maximum channel occupancy time (Tₘ COT,p), and allowed contention window sizes for different priority classes. The higher the priority class, the shorter the defer duration and the larger the allowed contention window size, allowing higher priority data to access the channel more quickly.

### Channel Access Priority Class Parameters for DL

| Channel | | | | | |
|---|---|---|---|---|---|
| Access | | | | | |
| Priority | | | | | allowed |
| Class (p) | mₚ | CW_{min, p} | CW_{max, p} | Tₘ COT, p | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

The use of an unlicensed local link for device collaboration, as described in FIGS. 8, 9, and 10, offers several benefits in terms of spectrum utilization efficiency. By leveraging unlicensed spectrum for the link between the primary UE 704 and the relay wireless device 706, the system can offload traffic from the licensed band (CC1), freeing up resources for other users served by the base station 702.

However, utilizing unlicensed spectrum requires careful coordination to avoid collisions with other devices operating in the same band. The LBT procedure amis to provide that transmissions occur only when the channel is idle.

The defer duration 1112 and random backoff 1120 introduce delays before channel access, which may impact the latency of the device collaboration system, especially for time-sensitive applications. The choice of CAPC and the corresponding parameters influence the LBT duration and the probability of collisions. Therefore, selecting an appropriate CAPC for the data traffic is important for balancing throughput and latency requirements.

Once the defer duration 1112 and the random backoff 1120 are completed, and if the channel is sensed as idle, data transmission can begin. The time during which the channel is occupied for data transmission is referred to as the COT 1130 (T_{cot}).

To enable data transmission in the device collaboration scenario with an unlicensed local link, as shown in FIGS. 9 and 10, the following necessary information are exchanged among the primary UE 704, the relay wireless device 706, and/or the base station 702:
The information about the frequency domain location of the LBT bandwidth in CC2.
For downlink (DL) transmission, how the relay wireless device 706 acquires the channel occupancy time (COT) in CC2:
   Option 1: The relay wireless device 706 performs LBT directly to acquire the COT for data forwarding.
   Option 2: The primary UE 704 performs LBT and shares the acquired COT with the relay wireless device 706.
For uplink (UL) transmission, how the primary UE 704 acquires the COT in CC2:
   The primary UE 704 performs LBT to acquire the COT for data transmission.

The information about the frequency domain location of the LBT bandwidth in CC2 allows the primary UE 704 and the relay wireless device 706 to perform LBT in the correct frequency domain location, avoiding interference with other devices operating in the unlicensed band.

In the downlink scenario, as illustrated in FIG. 9, the relay wireless device 706 is responsible for forwarding data to the primary UE 704 using CC2. To acquire the necessary COT for data forwarding, two options are considered. In the first option, the relay wireless device 706 directly performs LBT to acquire the COT. In the second option, the primary UE 704 performs LBT and shares the acquired COT with the relay wireless device 706.

In the uplink scenario, as shown in FIG. 10, the primary UE 704 is responsible for transmitting data to the relay wireless device 706 using CC2. To acquire the COT for data transmission, the primary UE 704 performs LBT. If the LBT is successful, the primary UE 704 can transmit data to the relay wireless device 706 using the acquired COT.

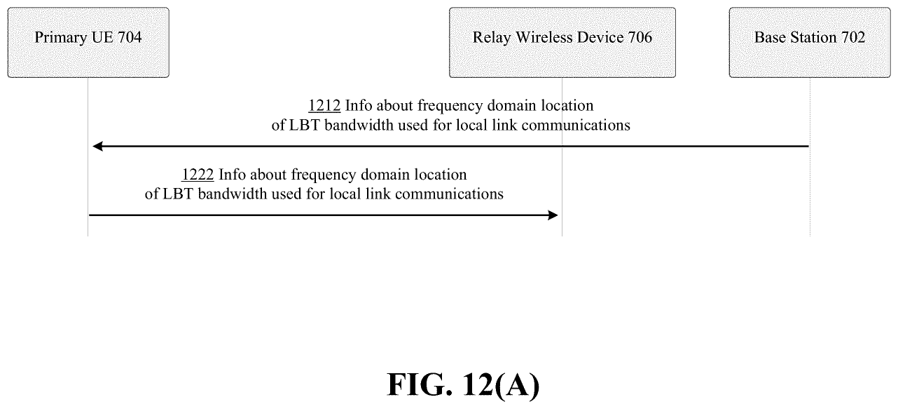

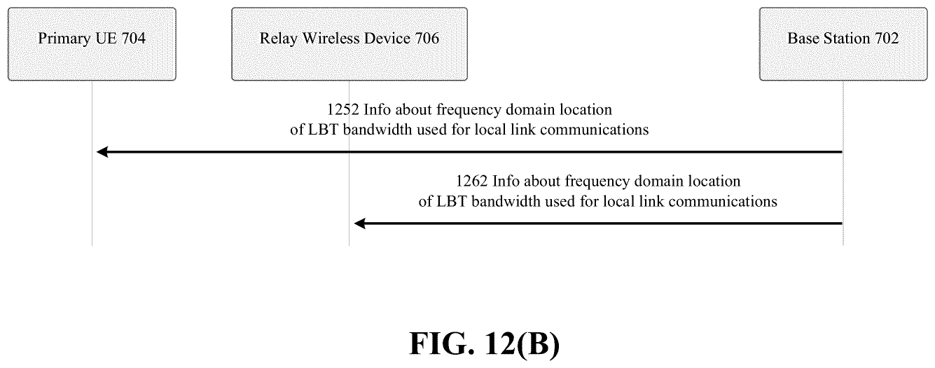

FIGS. 12(A) and 12(B) are diagrams 1200 and 1250, respectively, illustrating two options for exchanging information about the frequency domain location of the LBT bandwidth in CC2 for the local link between the primary UE 704 and the relay wireless device 706. These options consider the cases where the relay wireless device 706 may or may not have a SIM card, which affects its ability to communicate directly with the base station 702.

FIG. 12(A) shows the information exchange process when the relay wireless device 706 does not have a SIM card. In this case, the relay wireless device 706 cannot directly communicate with the base station 702, and the control signaling must be relayed through the primary UE 704.

In operation 1212, the base station 702 transmits information about the frequency domain location of the LBT bandwidth used for local link communications to the primary UE 704. This information allows the primary UE 704 to know where to perform LBT in CC2 for the local link communication with the relay wireless device 706.

Subsequently, in operation 1222, the primary UE 704 forwards the received information about the frequency domain location of the LBT bandwidth to the relay wireless device 706. This step enables the relay wireless device 706 to perform LBT in the correct frequency location before forwarding data to the primary UE 704 in the downlink scenario (as shown in FIG. 9).

Further, the primary UE 704 and the relay wireless device 706 have already completed a pairing process before this information exchange. The pairing process, which involves discovery and information exchange, allows the primary UE 704 and the relay wireless device 706 to establish a connection and learn about each other's capabilities. During the pairing process, the primary UE 704 may already receive the LBT bandwidth location information from the base station 702 and include it in the discovery messages exchanged with the relay wireless device 706. Further, the primary UE 704 and the relay wireless device 706 may have established a sidelink for communication. As such, the primary UE 704 may send the received information about the frequency domain location of the LBT bandwidth to the relay wireless device 706 through sidelink control information.

FIG. 12(B) depicts the information exchange process when the relay wireless device 706 has a SIM card. In this case, the relay wireless device 706 can communicate directly with both the base station 702 and the primary UE 704, providing more flexibility in the control signaling.

In operation 1252, the base station 702 transmits information about the frequency domain location of the LBT bandwidth used for local link communications to the primary UE 704.

Simultaneously with or subsequently to the operation 1252, in operation 1262, the base station 702 also sends the same information directly to the relay wireless device 706. The base station 702 may implement operations 1252 and 1262 in a Time Division Multiplexing (TDM) manner, where the information is sent to the primary UE 704 and the relay wireless device 706 at different times. Alternatively, the base station 702 may send the information to both devices simultaneously.

The order of operations 1252 and 1262 may vary depending on the system implementation and the specific scenario. The base station 702 provides the LBT bandwidth location information to both the primary UE 704 and the relay wireless device 706, allowing both devices to perform LBT in the correct frequency location.

Both options presented in FIGS. 12(A) and 12(B) providing the primary UE 704 and the relay wireless device 706 with the frequency domain location of the LBT bandwidth in CC2 for the local link communication.

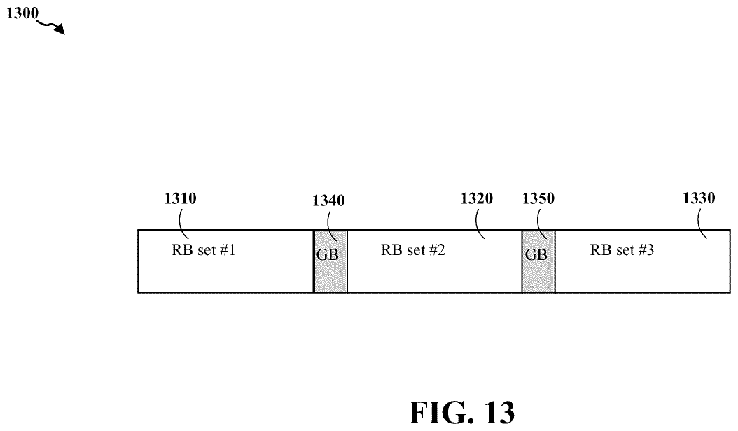

FIG. 13 is a diagram 1300 illustrating an example of the information about the frequency domain location of the LBT bandwidth in CC2. In this example, a resource block (RB) set is considered as the LBT bandwidth.

The diagram shows three RB sets: RB set 1310, RB set 1320, and RB set 1330. These RB sets are separated by guard bands, namely guard band 1340 and guard band 1350. The RB sets represent the frequency resources available for data transmission, while the guard bands serve as separation between the RB sets to minimize interference.

In certain configurations, the base station 702 can use RRC signaling to inform the primary UE 704 and the relay wireless device 706 about the frequency domain location of the guard bands. By knowing the location of the guard bands, the primary UE 704 and the relay wireless device 706 can determine the LBT bandwidth, which corresponds to the RB sets between the guard bands.

For example, if the base station 702 informs the primary UE 704 and the relay wireless device 706 about the location of guard band 1340 and guard band 1350, both devices can infer that RB set 1320 is the LBT bandwidth for performing LBT before transmitting or forwarding data on CC2.

In addition to the explicit signaling of guard band locations, the primary UE 704 and the relay wireless device 706 may be configured with a default guard band pattern that can be used when the base station 702 does not provide specific guard band information. In this case, the base station 702 can use a flag or a field in the RRC signaling or the DCI to indicate whether the default guard band pattern should be used. This allows the primary UE 704 and the relay wireless device 706 to determine the LBT bandwidth based on the default pattern.

Another example of providing the LBT bandwidth information is through the frequency domain resource allocation carried by the DCI. The base station 702 can use the DCI to directly specify the frequency resources allocated to a specific user.

If the DCI allocates the entire resources of an RB set to a single user equipment (UE), the UE can readily identify the LBT bandwidth. However, if the base station 702 divides the RB set's resources among multiple UEs, the DCI frequency domain resource allocation for a particular UE may only represent a portion of the LBT bandwidth.

For example, if an RB set is 20 MHz wide and the base station 702 allocates 10 MHZ each to two different UEs, the DCI frequency domain resource information for each UE will only cover half of the LBT bandwidth. In such cases, the UE may need additional information to determine the full LBT bandwidth.

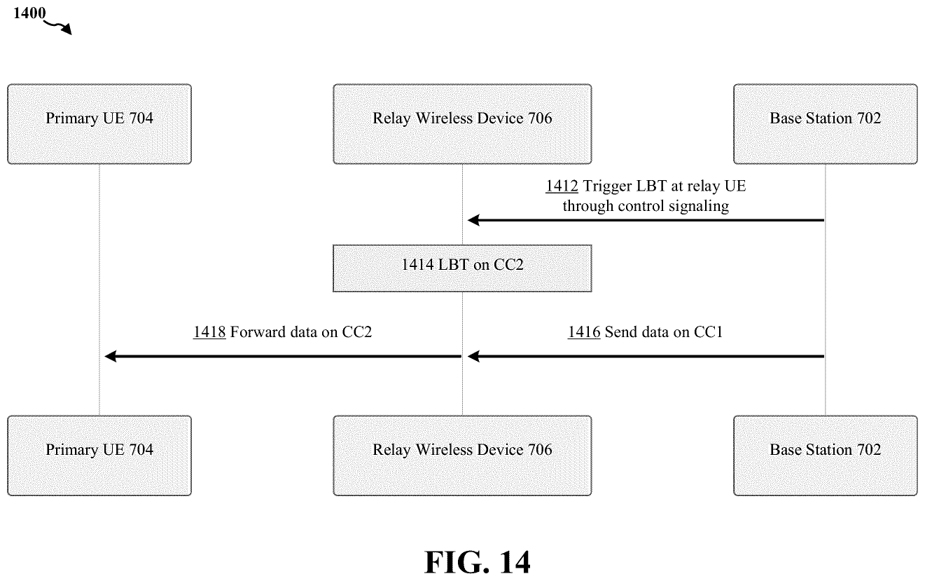

FIG. 14 is a diagram 1400 illustrating a downlink (DL) transmission procedure where the relay wireless device 706 performs LBT to acquire the Channel Occupancy Time (COT) for data forwarding. This procedure addresses the problem of letting the relay wireless device 706 know when to begin performing LBT to acquire the COT for DL data forwarding. The base station 702 triggers the LBT at the relay wireless device 706 and provides the necessary information for the relay wireless device 706 to perform LBT at the correct time and frequency resources.

In operation 1412, the base station 702 triggers the relay wireless device 706 to perform LBT. The LBT trigger information includes at least one of the following: (i) the time-domain resource to perform LBT, indicating when the relay wireless device 706 should start the LBT procedure, and (ii) the frequency-domain resource or location of the LBT bandwidth, specifying where the relay wireless device 706 should perform LBT in the frequency domain.

Upon receiving the LBT trigger, the relay wireless device 706 performs LBT on CC2 in operation 1414. The relay wireless device 706 senses the energy level within the specified LBT bandwidth and compares it to a predetermined threshold. If the sensed energy level is below the threshold for a certain duration, the relay wireless device 706 considers the channel to be idle and acquires the COT for data forwarding.

In operation 1416, the base station 702 sends DL data to the relay wireless device 706 on CC1. The relay wireless device 706 receives the data and translates the frequency domain resource from CC1 to CC2. This frequency translation involves shifting the carrier frequency of the received signal from the licensed band (CC1) to the unlicensed band (CC2) and allows the relay wireless device 706 to forward the data to the primary UE 704 on CC2 in operation 1418.

The relay wireless device 706 forwards the data to the primary UE 704 using the acquired COT on CC2. By performing LBT and acquiring the COT, the relay wireless device 706 may transmit the data on CC2 without interfering with other devices operating in the unlicensed spectrum.

This procedure enables the relay wireless device 706 to acquire the necessary COT for DL data forwarding.

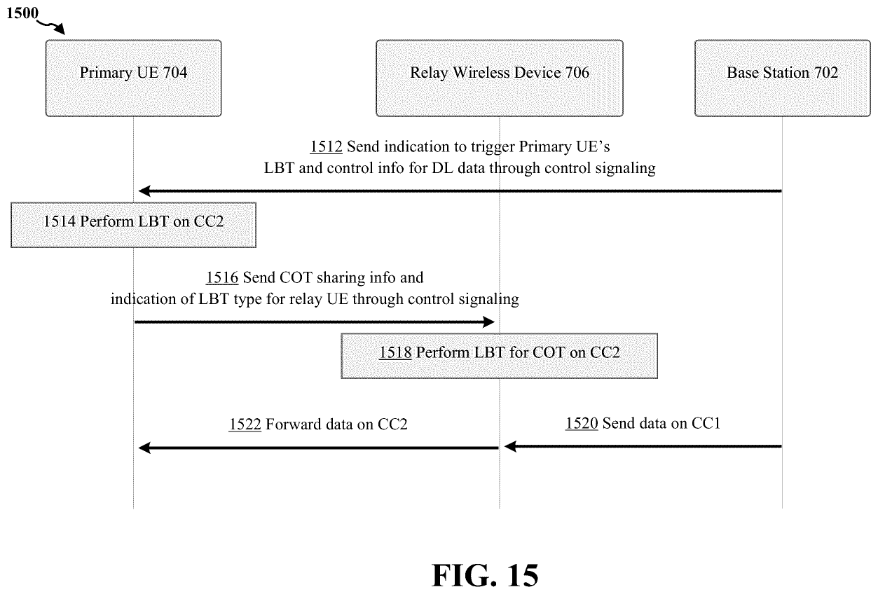

FIG. 15 is a diagram 1500 illustrating a downlink (DL) transmission procedure where the primary UE 704 performs LBT to acquire the Channel Occupancy Time (COT) and shares the acquired COT with the relay wireless device 706 for data forwarding. The base station 702 triggers the LBT at the primary UE 704 and provides the necessary control information for the primary UE 704 to perform LBT and share the acquired COT with the relay wireless device 706.

In operation 1512, the base station 702 sends an indication to trigger the primary UE 704 to perform LBT and provides control information for the DL data transmission. The control information may include a flag or a field to let the primary UE 704 know that it should share the acquired COT with the relay wireless device 706 for DL data forwarding. Upon receiving the indication, the primary UE 704 performs LBT on CC2 in operation 1514. The primary UE 704 senses the energy level within the specified LBT bandwidth and compares it to a predetermined threshold. If the sensed energy level is below the threshold for a certain duration, the primary UE 704 considers the channel to be idle and acquires the COT.

In operation 1516, the primary UE 704 sends COT sharing information and an indication of the LBT type to the relay wireless device 706. The COT sharing information includes at least one of the following: (i) the time domain resource of the COT, (ii) the frequency domain resource of the COT, (iii) the LBT type for the relay wireless device 706 to perform LBT to use the shared COT, and (iv) a flag or a field to trigger the relay wireless device 706 to start performing LBT for COT sharing. The primary UE 704 may send this information to the relay wireless device 706 using various methods, such as through CC1, as the relay wireless device 706 can also receive signals on CC1, or through a sidelink.

The primary UE 704 and the relay wireless device 706 have already completed a pairing process before this information exchange. The pairing process may involve discovery and information exchange through CC1 or a sidelink, enabling the primary UE 704 and the relay wireless device 706 to establish a connection and learn about each other's capabilities.

In operation 1518, the relay wireless device 706 performs LBT based on the received COT sharing information and the indicated LBT type. This LBT step determines whether the relay wireless device 706 can access the channel without causing interference, even though the COT was initially acquired by the primary UE 704. The relay wireless device 706 uses the shared COT acquired by the primary UE 704 to forward data to the primary UE 704 on CC2.

In operation 1520, the base station 702 sends DL data to the relay wireless device 706 on CC1. The relay wireless device 706 receives the data and translates the frequency domain resource from CC1 to CC2. This frequency translation involves shifting the carrier frequency of the received signal from the licensed band (CC1) to the unlicensed band (CC2).

In operation 1522, the relay wireless device 706 forwards the received data to the primary UE 704 using the shared COT on CC2. By utilizing the COT acquired by the primary UE 704, the relay wireless device 706 can transmit the data on CC2 without interfering with other devices operating in the unlicensed spectrum. This procedure enables the relay wireless device 706 to acquire the necessary COT for DL data forwarding through the primary UE 704's LBT and COT sharing.

The base station 702 indirectly learns about the LBT success and the relay wireless device 706's forwarding status through the CSI-RS measurements reported by the primary UE 704. As discussed in the presentation transcript, the base station 702 transmits CSI-RS to the relay wireless device 706, which forwards the CSI-RS to the primary UE 704 on CC2 when the LBT is successful. The primary UE 704 measures the CSI-RS on CC2 and reports the measurements to the base station 702. Based on the received CSI-RS measurements, the base station 702 can infer whether the relay wireless device 706 has acquired the COT and started forwarding data on CC2.

For example, if the relay wireless device 706 is off, the primary UE 704 will not be able to measure the CSI-RS on CC2 and will report this information to the base station 702 in its CSI-RS report. However, if the relay wireless device 706 is on and forwarding the CSI-RS from the base station 702 to the primary UE 704, the primary UE 704 will measure the CSI-RS on CC2 and report it accordingly, indicating that the relay wireless device 706 is forwarding data on CC2.

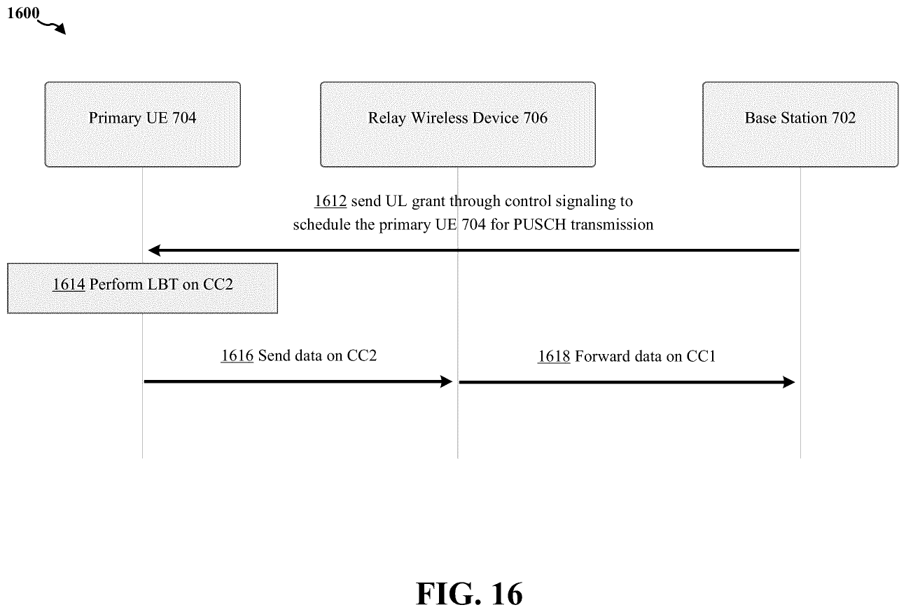

FIG. 16 is a diagram 1600 illustrating an uplink (UL) transmission procedure where the primary UE 704 performs LBT to acquire the Channel Occupancy Time (COT) for data transmission to the relay wireless device 706. This procedure addresses the problem of letting the primary UE 704 know when to begin performing LBT to acquire the COT for UL data transmission on the local link (link 720).

In operation 1612, the base station 702 sends an uplink grant to the primary UE 704, scheduling the primary UE 704 to send data via the Physical Uplink Shared Channel (PUSCH) on CC2. The uplink grant serves as an indication for the primary UE 704 to start the LBT procedure.

Upon receiving the uplink grant, the primary UE 704 performs LBT on CC2 in operation 1614. The primary UE 704 senses the energy level within the specified LBT bandwidth and compares it to a predetermined threshold. If the sensed energy level is below the threshold for a certain duration, the primary UE 704 considers the channel to be idle and acquires the COT for data transmission.

In operation 1616, if the LBT is successful, the primary UE 704 sends UL data to the relay wireless device 706 on CC2 using the acquired COT. The primary UE 704 transmits the data on the unlicensed band (CC2) to the relay wireless device 706 over the link 720.

The relay wireless device 706 receives the data from the primary UE 704 on CC2 and translates the frequency domain resource from CC2 to CC1 in operation 1618. This frequency translation involves shifting the carrier frequency of the received signal from the unlicensed band (CC2) to the licensed band (CC1). The relay wireless device 706 then forwards the translated data to the base station 702 on CC1 over the link 730.

It is important to note that the primary UE 704 transmits data on CC2 only if the LBT is successful. However, since CC1 is a licensed band, the primary UE 704 will transmit data on CC1 regardless of the LBT result on CC2. This means that even if the LBT on CC2 fails, indicating that the channel is occupied, the primary UE 704 can still transmit data to the base station 702 directly using the licensed band (CC1).

The primary UE 704 can utilize both the licensed band (CC1) and the unlicensed band (CC2) for data transmission. By performing LBT and acquiring the COT on CC2, the primary UE 704 can transmit additional data to the relay wireless device 706, which then forwards the data to the base station 702 on CC1. This allows the primary UE 704 to increase its transmission rank and potentially improve the overall throughput.

For example, if the primary UE 704 has two layers of data to transmit, it can send both layers on CC1 directly to the base station 702. However, if the LBT on CC2 is successful, the primary UE 704 can transmit additional layers of data (e.g., two more layers) on CC2 to the relay wireless device 706, which forwards the data to the base station 702 on CC1. This way, the primary UE 704 can effectively transmit four layers of data, increasing its transmission rank and potentially enhancing the throughput compared to using only the licensed band (CC1).

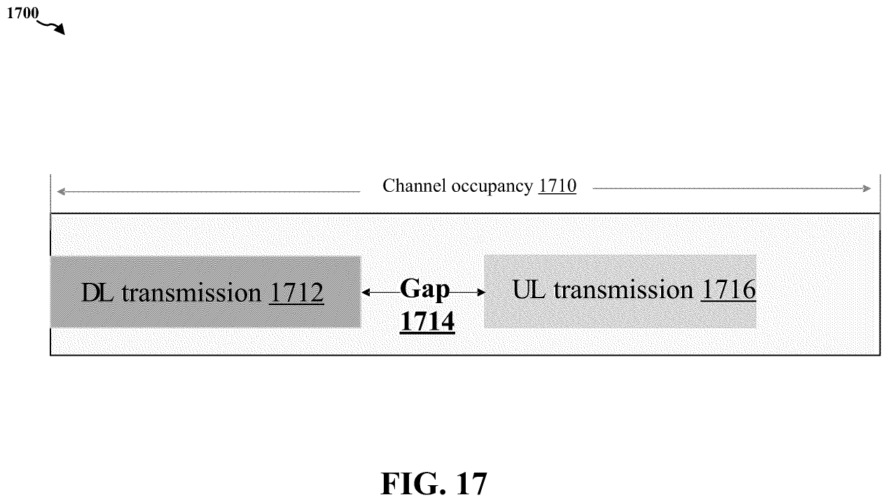

FIG. 17 is a diagram 1700 illustrating the concept of Channel Occupancy Time (COT) sharing in an unlicensed spectrum. COT represents the time duration a device can occupy the channel after performing LBT and acquiring the channel.

In this example, a single COT 1710, which consists of a downlink (DL) transmission 1712, followed by a gap 1714, and an uplink (UL) transmission 1716. The DL transmission 1712 represents the initial transmission initiated by the BS. After the DL transmission is completed, there may be remaining time within the COT. The gap 1714 represents the time interval between the end of the DL transmission 1712 and the beginning of the UL transmission 1716. For example, the COT may be shared between a UE and a base station if the COT has not ended when the initial transmission is finished.

The gap 1714 between the DL transmission 1712 and the UL transmission 1716 plays a crucial role in determining the LBT duration required for the UE before initiating the UL transmission 1716. The LBT duration depends on the length of the gap 1714:

If the gap 1714 is less than 16 μs, the UE can start the UL transmission 1716 without performing LBT (i.e., LBT duration=0 μs).

If the gap 1714 is equal to 16 μs, the UE must perform LBT for a duration of 16 μs before starting the UL transmission 1716.

If the gap 1714 is equal to 25 μs, the UE must perform LBT for a duration of 25 μs before starting the UL transmission 1716.

In the scenario depicted in FIG. 17, if the gap 1714 is 16 μs, the UE starts performing LBT immediately after the DL transmission 1712 ends. The UE can begin the UL transmission 1716 only after completing the 16 μs LBT procedure and determining that the channel is idle.

The COT sharing mechanism illustrated in FIG. 17 can be applied to the device collaboration scenario described supra. In the context of device collaboration, the relay wireless device 706 can acquire the COT for DL transmission and share the remaining COT with the primary UE 704 for further UL operation. Similarly, the primary UE 704 can acquire the COT for UL transmission and share the remaining COT with the base station 702 for further DL operation.

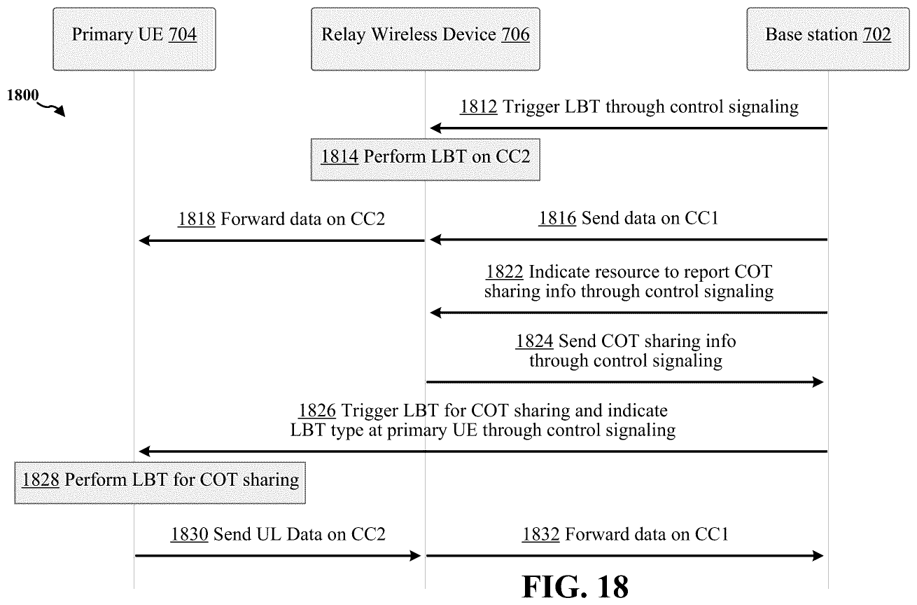

FIG. 18 is a diagram 1800 illustrating a COT sharing procedure for device collaboration with an unlicensed local link, where the relay wireless device 706 acquires the COT for downlink (DL) transmission and shares the remaining COT with the primary UE 704 for further uplink (UL) operation.

In operations 1812, 1814, 1816, and 1818, the base station 702 triggers the relay wireless device 706 to perform LBT on CC2, and the relay wireless device 706 acquires the COT for DL data forwarding, similar to the procedure described in FIG. 14. The base station 702 sends DL data to the relay wireless device 706 on CC1, and the relay wireless device 706 forwards the data to the primary UE 704 on CC2 using the acquired COT.

After the DL data forwarding is completed, if there is remaining time in the COT, the relay wireless device 706 can share the COT with the primary UE 704 for further UL transmission. This allows for efficient utilization of the unlicensed spectrum resources and enables the primary UE 704 to transmit UL data without performing a separate LBT procedure.

In operation 1822, the base station 702 indicates the resource for the relay wireless device 706 to report COT sharing information. This indication includes at least one of the following: (i) the time-domain resource for the relay wireless device 706 to report COT sharing information to the base station 702, or (ii) the frequency-domain resource for the relay wireless device 706 to report COT sharing information to the base station 702. The base station 702 may transmit this indication separately or jointly with the LBT trigger in operation 1812, and it may be sent before or after the DL data transmission in operation 1816.

In operation 1824, the relay wireless device 706 reports the COT sharing information to the base station 702. The COT sharing information includes at least one of the following: (i) the time-domain resource of the COT, indicating the remaining time available for UL transmission; (ii) the frequency-domain resource of the COT; or (iii) a flag or field to indicate whether the COT can be shared by the base station 702 for other UL transmissions.

In this example, the relay wireless device 706 has a SIM card and can directly communicate with the base station 702, as discussed in the presentation transcript and illustrated in FIG. 12(B).

In operation 1826, the base station 702 triggers the primary UE 704 to perform LBT for COT sharing and indicates the LBT type. Different LBT types correspond to different LBT durations, such as 16 μs or 25 μs, as shown in FIG. 17. The base station 702 also indicates the UL resource for the primary UE 704 to perform UL transmission using the shared COT.

In operation 1828, the primary UE 704 performs LBT based on the indicated LBT type to access the shared COT for UL transmission.

If the LBT is successful, in operation 1830, the primary UE 704 sends UL data to the relay wireless device 706 on CC2 using the shared COT. The relay wireless device 706 then translates the frequency-domain resource of the received signal from CC2 to CC1 and forwards it to the base station 702 in operation 1832.

This COT sharing procedure allows the relay wireless device 706 to efficiently share the remaining COT with the primary UE 704 for UL transmission, reducing the need for additional LBT procedures and improving the overall resource utilization in the unlicensed spectrum.

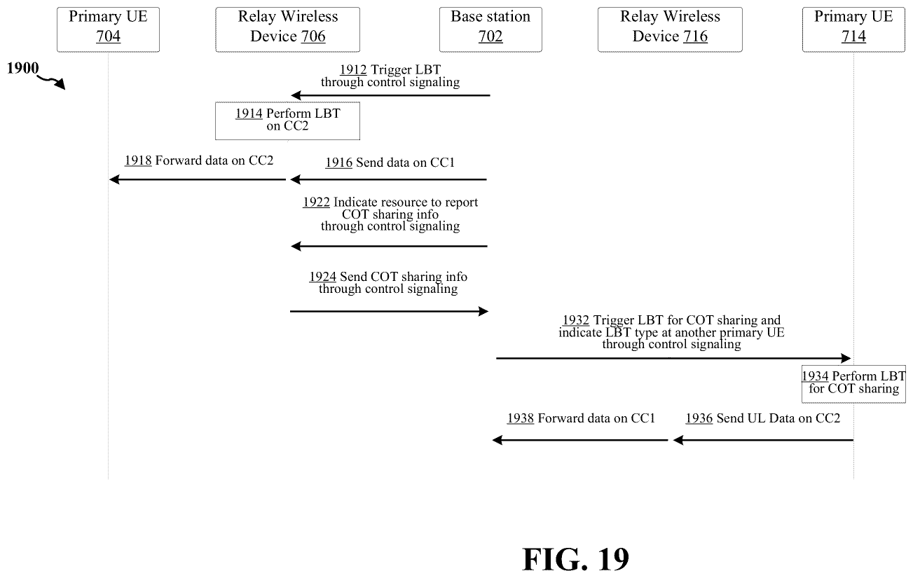

FIG. 19 is a diagram 1900 illustrating a COT sharing procedure for device collaboration with an unlicensed local link, where the relay wireless device 706 acquires the COT for downlink (DL) transmission and shares the remaining COT with another primary UE, primary UE 714 for further uplink (UL) operation. A relay wireless device 716 is paired with the primary UE 714.

In operations 1912, 1914, 1916, and 1918, the base station 702 triggers the relay wireless device 706 to perform LBT on CC2, and the relay wireless device 706 acquires the COT for DL data forwarding, similar to the procedure described in FIG. 14. The base station 702 sends DL data to the relay wireless device 706 on CC1, and the relay wireless device 706 forwards the data to the primary UE 704 on CC2 using the acquired COT.

In operation 1922, the base station 702 indicates the resource for the relay wireless device 706 to report COT sharing information. This indication includes at least one of the following: (i) the time-domain resource for the relay wireless device 706 to report COT sharing information to the base station 702, or (ii) the frequency-domain resource for the relay wireless device 706 to report COT sharing information to the base station 702. The base station 702 may transmit this indication separately or jointly with the LBT trigger in operation 1912, and it may be sent before or after the DL data transmission in operation 1916.

In operation 1924, the relay wireless device 706 reports the COT sharing information to the base station 702. The COT sharing information includes at least one of the following: (i) the time-domain resource of the COT, indicating the remaining time available for UL transmission; (ii) the frequency-domain resource of the COT; or (iii) a flag or field to indicate whether the COT can be shared by the base station 702 for other UL transmissions.

In operation 1932, after receiving the COT sharing information, the base station 702 triggers the primary UE 714 to perform LBT for COT sharing and indicates the LBT type to the primary UE 714. Different LBT types correspond to different LBT durations, such as 16 μs or 25 μs, as shown in FIG. 17. The base station 702 also indicates the UL resource for the primary UE 714 to perform UL transmission using the shared COT.

In operation 1934, the primary UE 714 performs LBT based on the indicated LBT type to access the shared COT for UL transmission. If the LBT is successful, in operation 1936, the primary UE 714 sends UL data to the relay wireless device 716 on CC2 using the shared COT. The relay wireless device 716 then translates the frequency-domain resource of the received signal from CC2 to CC1 and forwards it to the base station 702 in operation 1938.

The primary UE 714 can use the shared COT for UL data transmission to the base station 702 through the relay wireless device 716. The primary UE 714 and the relay wireless device 716 represent other UEs that are served by the base station 702 in UL device collaboration (devCo) mode but do not initiate the COT.

Two possible cases for the UL transmission of the primary UE 714 are illustrated in FIG. 19:
Case 1: The primary UE 714 transmits data in both CC1 and CC2. In this case, the primary UE 714 sends UL data directly to the base station 702 using CC1 and to the relay wireless device 716 using CC2. The relay wireless device 716 then forwards the received data from CC2 to the base station 702 using CC1.
Case 2: The primary UE 714 transmits data only in CC2. In this case, the primary UE 714 sends UL data to the relay wireless device 716 using CC2, and the relay wireless device 716 forwards the received data to the base station 702 using CC1. The primary UE 714 does not transmit data directly to the base station 702 using CC1.

This procedure allows the relay wireless device 706 to share the remaining COT with the primary UE 714 for UL transmission, improving the overall resource utilization in the unlicensed spectrum.

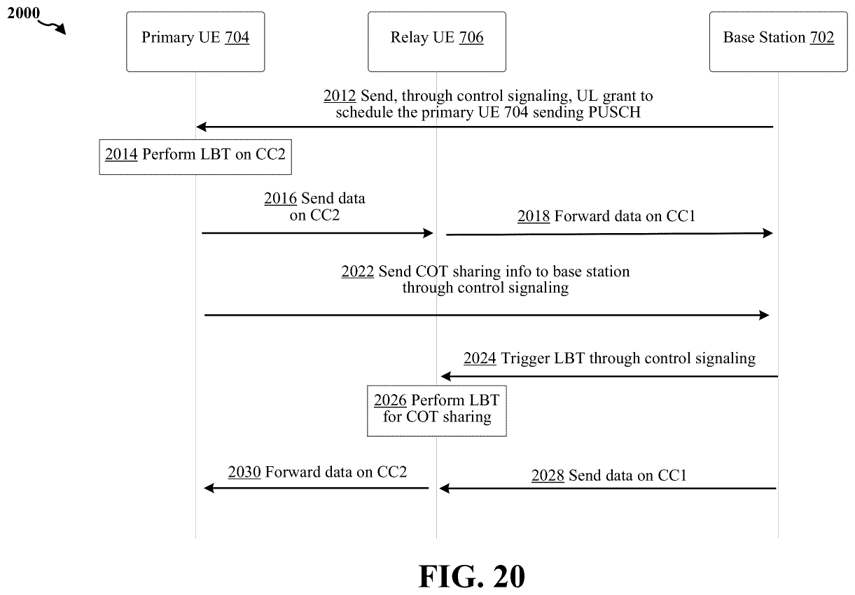

FIG. 20 is a diagram 2000 illustrating a COT sharing procedure for device collaboration with an unlicensed local link, where the primary UE 704 acquires the COT for uplink (UL) transmission and shares the remaining COT with the base station 702 for further downlink (DL) operation.

In operation 2012, the base station 702 sends an uplink grant to the primary UE 704, scheduling the primary UE 704 to send data via the Physical Uplink Shared Channel (PUSCH) on CC2. The uplink grant serves as an indication for the primary UE 704 to start the LBT procedure.

Upon receiving the uplink grant, the primary UE 704 performs LBT on CC2 in operation 2014. The primary UE 704 senses the energy level within the specified LBT bandwidth and compares it to a predetermined threshold. If the sensed energy level is below the threshold for a certain duration, the primary UE 704 considers the channel to be idle and acquires the COT for data transmission.

In operation 2016, if the LBT is successful, the primary UE 704 sends UL data to the relay wireless device 706 on CC2 using the acquired COT. The primary UE 704 transmits the data on the unlicensed band (CC2) to the relay wireless device 706 over the link 720.

The relay wireless device 706 receives the data from the primary UE 704 on CC2 and translates the frequency domain resource from CC2 to CC1 in operation 2018. This frequency translation involves shifting the carrier frequency of the received signal from the unlicensed band (CC2) to the licensed band (CC1). The relay wireless device 706 then forwards the translated data to the base station 702 on CC1 over the link 730.

After the UL data transmission is completed, if there is remaining time in the COT, the primary UE 704 can share the COT with the base station 702 for further DL transmission. This allows for efficient utilization of the unlicensed spectrum resources and enables the base station 702 to transmit DL data without performing a separate LBT procedure.

In operation 2022, the primary UE 704 reports the COT sharing information to the base station 702. The COT sharing information includes at least one of the following: (i) the time-domain resource of the COT, indicating the remaining time available for DL transmission; (ii) the frequency-domain resource of the COT; or (iii) a flag or field to indicate whether the COT can be shared by the base station 702 for other DL transmissions.

In operation 2024, after receiving the COT sharing information, the base station 702 triggers the relay wireless device 706 to perform LBT for COT sharing. The base station 702 indicates the frequency-domain resource for the relay wireless device 706 to perform LBT.

In operation 2026, the relay wireless device 706 performs LBT based on the indicated frequency-domain resource to access the shared COT for DL transmission.

If the LBT is successful, in operation 2028, the base station 702 sends DL data to the relay wireless device 706 on CC1 using the shared COT. The relay wireless device 706 then translates the frequency-domain resource of the received signal from CC1 to CC2 and forwards it to the primary UE 704 in operation 2030.

The COT sharing information reported by the primary UE 704 in operation 2022 is similar to the COT sharing information reported by the relay wireless device 706 in the previous examples, such as in FIG. 18. It provides the base station 702 with the necessary information to determine the remaining COT duration and the frequency resources available for DL transmission.

This COT sharing procedure allows the primary UE 704 to efficiently share the remaining COT with the base station 702 for DL transmission, improving the overall resource utilization in the unlicensed spectrum. By leveraging the primary UE 704's acquired COT, the base station 702 can transmit DL data to the primary UE 704 through the relay wireless device 706 without the need for additional LBT procedures, reducing latency and enhancing the efficiency of the device collaboration system.

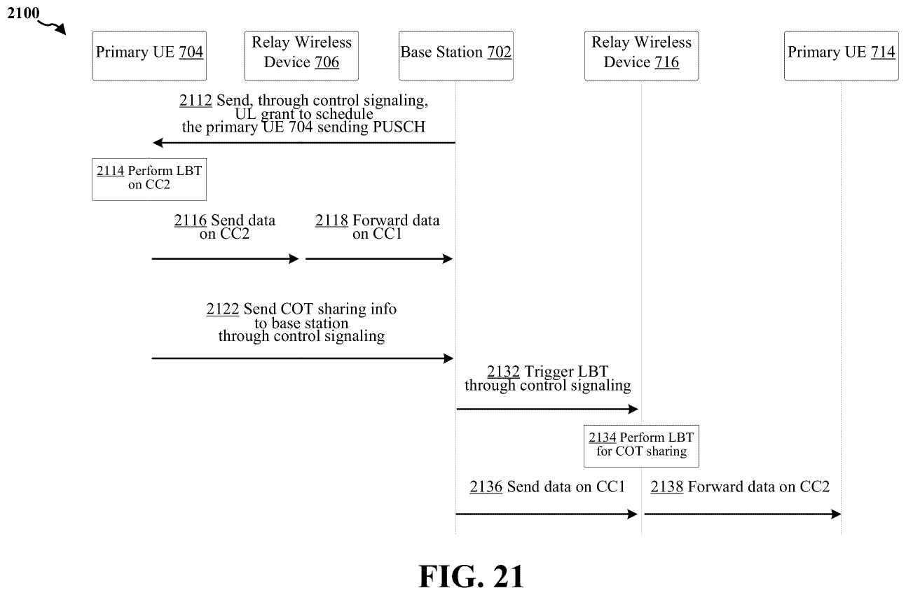

FIG. 21 is a diagram 2100 illustrating a COT sharing procedure for device collaboration with an unlicensed local link, where the primary UE 704 acquires the COT for uplink (UL) transmission and shares the remaining COT with the base station 702 for further downlink (DL) operation to another primary UE 714 through another relay wireless device 716.

Operations 2112, 2114, 2116, 2118, and 2122 are the same as operations 2012, 2014, 2016, 2018, and 2022 in FIG. 20, respectively. The primary UE 704 receives an uplink grant from the base station 702 (op. 2112), performs LBT on CC2 (op. 2114), sends UL data to the relay wireless device 706 on CC2 (op. 2116), which forwards the data to the base station 702 on CC1 (op. 2118). The primary UE 704 then reports the COT sharing information to the base station 702 (op. 2122).

After receiving the COT sharing information, in operation 2132, the base station 702 triggers another relay wireless device, relay wireless device 716, to perform LBT for COT sharing. The relay wireless device 716 is paired with another primary UE, primary UE 714, which is different from the primary UE 704 that initiated the COT.

In operation 2134, the relay wireless device 716 performs LBT based on the trigger from the base station 702 to access the shared COT for DL transmission.

If the LBT is successful, in operation 2136, the base station 702 sends DL data to the relay wireless device 716 on CC1. The relay wireless device 716 then translates the frequency-domain resource of the received signal from CC1 to CC2 and forwards it to the primary UE 714 in operation 2138.

This procedure demonstrates that the COT, initially acquired by the primary UE 704 for UL transmission, can be used by another relay wireless device 716 to forward DL data sent by the base station 702 to another primary UE 714. The primary UE 714 and the relay wireless device 716 represent other UEs that are served by the base station 702 in DL device collaboration (devCo) mode but do not initiate the COT.

There may be two possible cases for the DL transmission to the primary UE 714:
Case 1: The primary UE 714 receives data from both CC1 and CC2. In this case, the primary UE 714 receives DL data directly from the base station 702 using CC1 and from the relay wireless device 716 using CC2. The relay wireless device 716 forwards the data received from the base station 702 on CC1 to the primary UE 714 on CC2.
Case 2: The primary UE 714 receives data only from CC2. In this case, the primary UE 714 receives DL data from the relay wireless device 716 using CC2. The relay wireless device 716 forwards the data received from the base station 702 on CC1 to the primary UE 714 on CC2. The primary UE 714 does not receive data directly from the base station 702 using CC1.

This COT sharing procedure allows the base station 702 to efficiently utilize the remaining COT, initially acquired by the primary UE 704, for DL transmission to another primary UE 714 through another relay wireless device 716. By using the shared COT, the another relay wireless device 716 can transmit DL data without the need for additional LBT procedures, reducing latency and enhancing the efficiency of the device collaboration system in the unlicensed spectrum.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
discovering a relay wireless device for local communications on an unlicensed carrier; and
communicating, after a listen-before-talk (LBT) procedure is successful on the unlicensed carrier, data with the relay wireless device on the unlicensed carrier through the local communications for further communicating the data with a base station.

2. The method of claim 1, further comprising:
receiving, from the base station and on a licensed carrier, an uplink grant and information about a frequency domain location of an LBT bandwidth for the local communications with the relay wireless device on the unlicensed carrier; and
performing the LBT procedure on the LBT bandwidth to acquire a channel occupancy time (COT) for the local communications on the unlicensed carrier,
wherein the communicating the data with the relay wireless device includes transmitting the data to the relay wireless device in the acquired COT and according to the uplink grant.

3. The method of claim 2, further comprising:
transmitting, to the base station, information about a remaining time duration of the COT after the communicating the data with the relay wireless device, wherein the base station uses the remaining time duration of the COT for downlink data transmission.

4. The method of claim 3, wherein the information about the remaining time duration of the COT includes at least one of:
a time domain resource of the remaining time duration of the COT;
a frequency domain resource of the remaining time duration of the COT; or
an indication of whether the remaining time duration of the COT can be shared by the base station for other downlink transmissions.

5. The method of claim 1, wherein the LBT procedure is performed by the relay wireless device, and wherein the communicating the data with the relay wireless device includes receiving the data from the relay wireless device.

6. The method of claim 5, further comprising:
receiving, from the base station and on a licensed carrier, an indication to trigger the relay wireless device to perform the LBT procedure and information about a frequency domain location of an LBT bandwidth for the local communications with the relay wireless device on the unlicensed carrier; and
triggering the relay wireless device with the information.

7. The method of claim 5, further comprising:
receiving, from the relay wireless device, information about a remaining time duration of the COT acquired by the relay wireless device after the communicating the data with the relay wireless device, wherein the base station uses the remaining time duration of the COT for uplink data transmission of another UE.

8. The method of claim 7, wherein the information about the remaining time duration of the COT includes at least one of:
a time domain resource of the remaining time duration of the COT;
a frequency domain resource of the remaining time duration of the COT; or
an indication of whether the remaining time duration of the COT can be shared by the base station for other uplink transmissions.

9. The method of claim 1, further comprising:
receiving, from the base station, an indication to trigger the UE to perform the LBT procedure and information about a frequency domain location of an LBT bandwidth for the local communications with the relay wireless device on the unlicensed carrier;
performing the LBT procedure on the LBT bandwidth to acquire a channel occupancy time (COT) for the local communications on the unlicensed carrier; and
transmitting, to the relay wireless device, COT sharing information and an indication of an LBT type for the relay wireless device to perform an LBT procedure to use the acquired COT for data forwarding, wherein the communicating the data with the relay wireless device includes receiving the data from the relay wireless device in the acquired COT.

10. The method of claim 9, wherein the COT sharing information includes at least one of:
a time domain resource of the COT;
a frequency domain resource of the COT; or
the LBT type for the relay wireless device to perform the LBT procedure to use the acquired COT.

11. A method of wireless communication of a relay wireless device, comprising:
discovering a user equipment (UE) for local communications on an unlicensed carrier; and
communicating, after a listen-before-talk (LBT) procedure is successful on the unlicensed carrier, data with the UE on the unlicensed carrier through the local communications for communicating the data between the UE and a base station.

12. The method of claim 11, further comprising:
receiving, from the base station and on a licensed carrier, a trigger to perform the LBT procedure and information about a frequency domain location of an LBT bandwidth for the local communications with the UE on the unlicensed carrier;
performing the LBT procedure on the LBT bandwidth to acquire a channel occupancy time (COT) for the local communications on the unlicensed carrier; and
receiving, from the base station and on the licensed carrier, the data after the LBT procedure is successful,
wherein the communicating the data with the UE includes forwarding the data to the UE in the acquired COT.

13. The method of claim 12, further comprising:
receiving, from the base station, an indication of a resource to report COT sharing information; and
transmitting, to the base station, the COT sharing information including at least one of:
a time domain resource of a remaining time duration of the COT after the communicating the data with the UE;
a frequency domain resource of the remaining time duration of the COT; or
an indication of whether the remaining time duration of the COT can be shared by the base station for other uplink transmissions.

14. The method of claim 11, wherein the LBT procedure is performed by the UE, and wherein the communicating the data with the UE includes receiving the data from the UE in a COT acquired by the UE.

15. The method of claim 14, further comprising:
receiving, from the UE, COT sharing information and an indication of an LBT type; and
performing an LBT procedure of the LBT type to use the COT acquired by the UE for data forwarding,
wherein the COT sharing information includes at least one of:
a time domain resource of the COT;
a frequency domain resource of the COT; or
the LBT type.

16. The method of claim 11, further comprising:
receiving, from the base station and on a licensed carrier, information about a frequency domain location of an LBT bandwidth for the local communications with the UE on the unlicensed carrier.

17. The method of claim 16, wherein the information about the frequency domain location of the LBT bandwidth includes at least one of:
a location of a frequency domain resource of a guard band;
a flag or field to indicate whether a default guard band pattern is used; or
a frequency domain resource allocation.

18. The method of claim 11, further comprising:
receiving, from the UE, information about a frequency domain location of an LBT bandwidth for the local communications with the UE on the unlicensed carrier.

19. The method of claim 11, wherein the relay wireless device does not have a SIM card and cannot directly communicate with the base station.

20. The method of claim 11, wherein the relay wireless device has a SIM card and can directly communicate with the base station.
